(19) United States
(12) Patent Application Publication
(10) Pub. No.: US 2014/0019660 A1
(43) Pub. Date: Jan. 16, 2014

(54) CONTROLLING DEVICE

(71) Applicant: Azbil Corporation, Tokyo (JP)

(72) Inventor: Takanori AOKI, Tokyo (JP)

(21) Appl. No.: 13/933,523

(22) Filed: Jul. 2, 2013

(30) Foreign Application Priority Data
Jul. 2, 2012 (JP) 2012-148215

(51) Int. Cl. G06F 13/40

(52) U.S. Cl. CPC G06F 13/40
USPC 710/302

(57) ABSTRACT

A controlling device includes a controlling device main unit and a terminal block attached removably to the controlling device main unit. The terminal block is provided with an IC chip disposed in a specific position. The controlling device main unit is provided with an interface that, in a state wherein the terminal block is attached, is positioned at a position in proximity to the IC chip that is disposed in the terminal block, and reads and writes information from and to the IC chip without contact.

### CROSS REFERENCE TO RELATED APPLICATION

This application claims priority to Japanese Patent Application No. 2012-148215, filed on Jul. 2, 2012, the entire content of which being hereby incorporated herein by reference.

### FIELD OF TECHNOLOGY

The present invention relates to a controlling device including a controlling device main unit and a terminal block that is attached removably to the controlling device main unit.

### BACKGROUND

Controlling devices, such as temperature adjusting instruments, communication devices, display devices, driving devices, input/output devices, and power supply devices, are equipped with terminal blocks for inputting power and signals from sensors, or the like, and for outputting signals to the devices that are controlled. In recent years, structures wherein the terminal blocks can be removed from the controlling device main units have been used in order to enhance convenience in operations at the time of maintenance operations, and to accommodate miniaturization of the equipment.

For example, Japanese Unexamined Patent Application Publications 2002-203616 and 2010-146958 disclose controlling devices that use such structures. In controlling devices that use such structures, it is not necessary to perform the laborious operations of external wiring, for connecting wires, when the controlling device main unit has failed or malfunctioned. This makes it possible to swap the controlling device main unit easily for a spare, enabling the device to be restored rapidly.

However, in controlling devices that use a structure wherein the terminal block is removable, as described above, when swapping the controlling device main unit for a spare, operations are required for setting up the controlling device main unit again after swapping, such as setting up the setting values pertaining to the operations of the controlling device main unit from before the swap. In this case, the operator may have to perform the set up through manual input, or may have to use a specialized tool using a personal computer (hereinafter abbreviated “PC”), and often the setup may fail due to a simple error in the operations, or the settings may be incorrect. Moreover, the greater the number of units that are swapped, the more complex the setup operations become, and the more likely such problems become.

The present invention is to solve such problems, and an aspect thereof is to provide a controlling device wherein the controlling device main unit can be swapped for a spare without setup operations through manual input or through the use of a specialized tool.

### SUMMARY

An example of the present invention, in order to achieve the aspect set forth above is a controlling device including a controlling device main unit and a terminal block that is attached removably to the controlling device main unit. The terminal block is provided with an IC chip that is disposed in a specific position. The controlling device main unit is provided with an interface that, in the state wherein the terminal block is attached, is positioned at a position that is in proximity to the IC chip that is disposed in the terminal block, and is able to read and write information to and from the IC chip without contact.

For example, in the present invention, the information that is written to the IC chip is setting values pertaining to the operation of the controlling device main unit. In this case, even if the controlling device main unit is removed, still the setting values pertaining to the operation of the controlling device main unit remain in the IC chip of the terminal block side. Because of this, when the controlling device main unit is swapped for a spare, the controlling device main unit after swapping reads in the setting values pertaining to the operation of the controlling device main unit from before swapping, to inherit the settings that have been read, enabling operations to start again immediately.

In the present invention, the information written to the IC chip may also be information pertaining to maintenance or device calibration, information pertaining to faults, malfunctions, and repairs of the past, or data pertaining to self-diagnostic results from the past.

In the present invention, an IC chip is disposed at a specific position in the terminal block, and the controlling device main unit is provided with an interface that, in the state wherein the terminal block is attached, is positioned at a position that is in proximity to the IC chip that is disposed in the terminal block, and is able to read and write information to and from the IC chip without contact, so that information such as setting values pertaining to the operation of the controlling device main unit from before a swap will remain in the IC chip on the terminal block side, making it possible to swap the controlling device main unit for a spare without setup operations using manual input or using a specialized tool.

### BRIEF DESCRIPTION OF THE DRAWINGS

FIG. 1 is an assembly perspective diagram illustrating the structure of an example of a controlling device according to the present invention.

FIG. 2 is a side view diagram of the controlling device and a cross-sectional diagram illustrating schematically the structure of the internal portion thereof.

FIG. 3 is an explanatory diagram illustrating the procedure for attaching the terminal block to the controlling device main unit in the controlling device.

FIG. 4 is a diagram when the controlling device in a provisionally secured state is viewed from the direction of arrow B in FIG. 1.

FIG. 5 is a diagram illustrating the state wherein the slide member is released in the controlling device.

FIG. 6 is a diagram illustrating the state wherein the slide member is secured in the controlling device.

FIG. 7 is a functional block diagram of the controlling portion in the controlling device.

### DETAILED DESCRIPTION

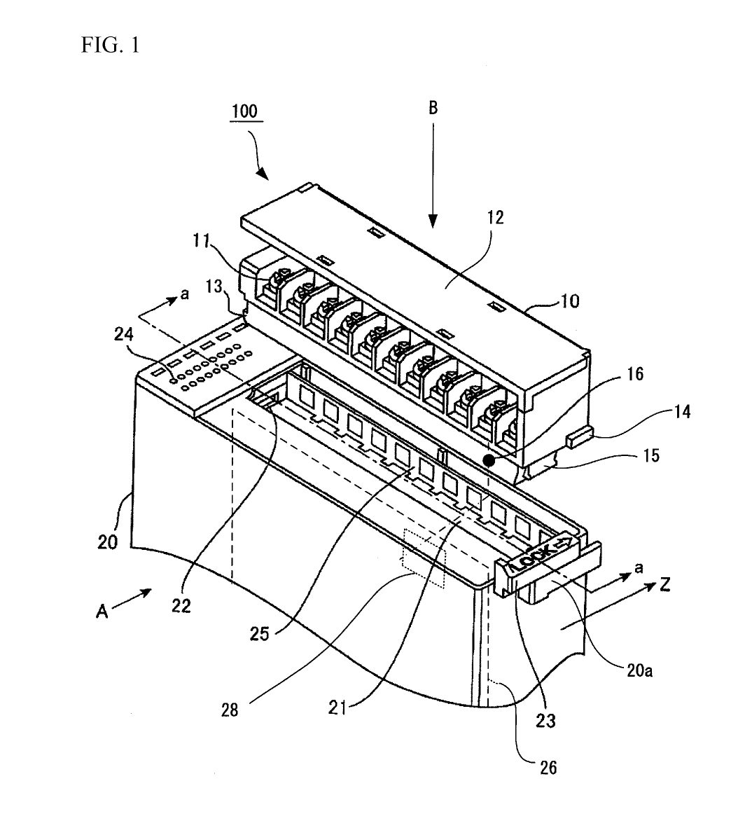

An example according to the present invention will be explained below in detail, based on the drawings. FIG. 1 is an assembly oblique view illustrating the structure of an example of a controlling device according to the present invention.

In the present example, the controlling device 100 is structured from a terminal block 10, having a plurality of terminal portions 11, and a controlling device main unit 20, having a terminal block attaching opening 21 for attaching the terminal block 10.

The terminal block 10 is provided with a plurality of terminal portions 11, and a terminal cover 12 for covering over the terminal portions 11, where a first protruding portion 13 is provided in the vicinity of the bottom face on one end in the lengthwise direction, and a second protruding portion 14 and a third protruding portion 15 are provided in the vicinity of the bottom face on the other end in the lengthwise direction. The first, second, and third protrusions 13, 14, and 15 are key-shaped or tab-shaped.

Moreover, on a lower portion of the front face portion of the terminal block 10, an IC chip 16 is embedded in a specific location. In a state wherein the terminal block 10 is attached to the controlling device main unit 20, the setting values pertaining to the operation of the controlling device main unit 20, information pertaining to maintenance and equipment calibration, information pertaining to faults, malfunctions, and repairs in the past, and information such as data for self-diagnostic results in the past, are written to the IC chip 16. Writing of information from the controlling device main unit 20 to the IC chip 16, and reading of information, will be explained below.

The controlling device main unit 20, on the inside of one lengthwise-direction end of the terminal block attaching opening 21, is provided with a fitting indentation 22 into which the first protruding portion 13 can fit, and is provided with a securing member 20a on the side face on the other lengthwise-direction end of the terminal block attaching opening 21. A slide member 23, which moves sliding in the direction of the arrow Z on the securing member 20a, to lock the terminal block 10 that is attached to the controlling device main unit 20 is provided on the top face of the securing member 20a. The locking of the terminal block 10 by the slide member 23 will be described below. Moreover, a displaying portion 24 is provided on the top face of the controlling device main unit 20, and printed substrates 25 and 26 are contained on the inside of the controlling device main unit 20.

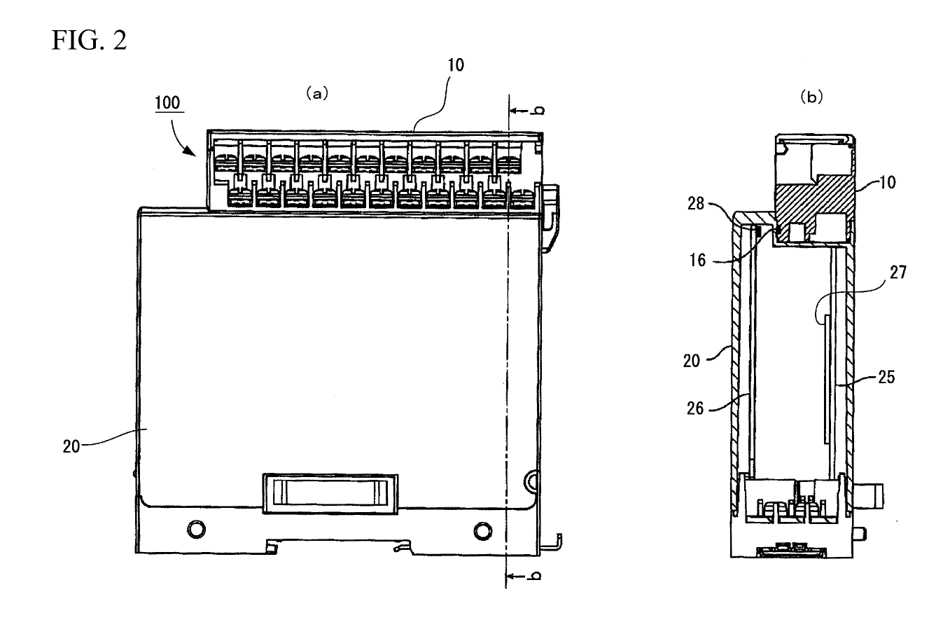

FIG. 2 is a side view of the controlling device 100 and a cross-sectional diagram illustrating the schematic structure of the interior thereof, where FIG. 2 (a) is a side view of the controlling device 100 when viewed from the A direction in FIG. 1, and FIG. 2 (b) is a cross-sectional diagram along the section b-b in FIG. 2 (a). A controlling portion 27, structured from a CPU, a microcontroller, or the like, as the internal circuitry, is mounted on the printed substrate 25 that is contained within the controlling device main unit 20. Moreover, an IC chip reader/writer 28, which is able to read and write information from/to the IC chip 16 without contact, is positioned in a position that, when in a state wherein the terminal block 10 is attached, is near to the IC chip 16 that is embedded in the terminal block 10, on the printed substrate 26 that is contained within the controlling device main unit 20. This IC chip reader/writer 28 corresponds to the “interface” in the present invention.

### Attaching the Terminal Block to the Controlling Device Main Unit

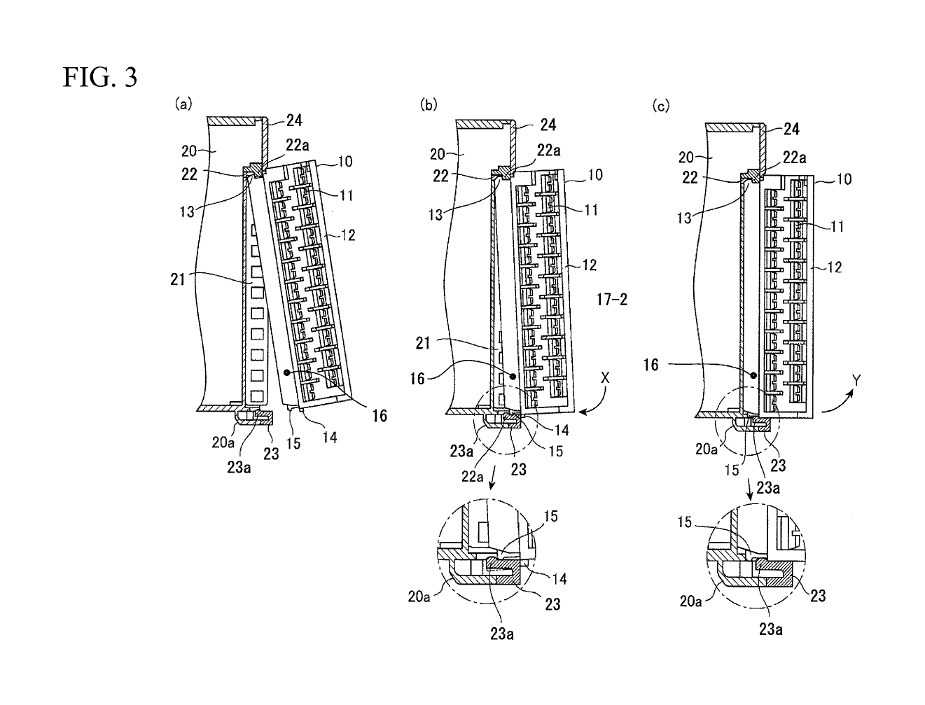

FIG. 3 is an explanatory diagram illustrating the procedure for attaching the terminal block 10 to the controlling device main unit 20, shown for the cross-sectional diagram along the section a-a in FIG. 1. The procedure for attaching the terminal block 10 to the controlling device main unit 20 is shown in the sequence from FIG. 3 (a) through (c).

First, as illustrated in FIG. 3 (a), the first protruding portion 13 that is provided on one lengthwise-direction end of the terminal block 10 is fitted into the fitting indentation 22 of the terminal block attaching opening 21. Following this, as illustrated in FIG. 3 (b), the bottom side end portion of the terminal block 10 is pushed in the direction of the arrow X.

The slide member 23 is provided on the securing member 20a on the side face on the other lengthwise-direction end of the terminal block attaching opening 21. The cross-sectional shape of this slide member 23 is essentially a block-U shape, and a locking portion 23a that protrudes toward the inside of the terminal block attaching opening 21 is formed on the end portion that has this block-U shape.

When the bottom side end portion of the terminal block 10 is pushed in the direction of the arrow X, the pressure causes the third protruding portion 15 of the terminal block 10 to push against the locking portion 23a of the slide member 23, and when pushed further, the locking portion 23a flexes as shown by the dotted line in the expanded view in FIG. 3 (b), enabling the third protruding portion 15 to go past the locking portion 23a. Thereafter, the release of the flexing of the locking portion 23a causes the key-shaped (tab-shaped) protrusion of the third protruding portion 15 to interlock with a protruding part of the locking portion 23a, to provisionally secure the terminal block 10 to the controlling device main unit 20.

The state wherein the terminal block 10 is provisionally secured to the controlling device main unit 20 is illustrated in FIG. 3 (c). When in this provisionally secured state, even if a force were to be applied to the terminal block 10 in the direction of the arrow Y, a catch portion 22a is formed between the fitting indentation 22 and the displaying portion 24, that is, on the side face of the fitting indentation 22 in the direction of removal of the terminal block 10, and thus the first protruding portion 13 would strike against the catch portion 22a, preventing the terminal block 10 from coming out in the direction of the arrow Y. Furthermore, because the key-shaped (tab-shaped) protrusion of the third protruding portion 15 interlocks with the protruding part of the locking portion 23a, the terminal block 10 is prevented even more reliably from coming out in the direction of the arrow Y.

### Locking the Terminal Block by the Slide Member

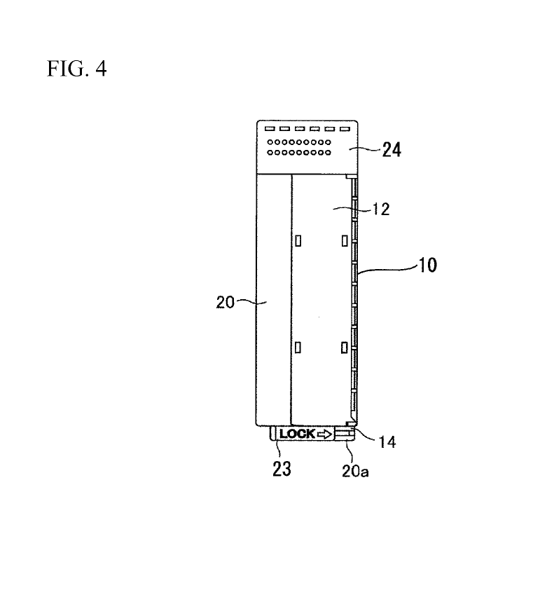

FIG. 4 is a diagram viewing the controlling device 100, in the provisionally secured state, from the direction of the arrow B in FIG. 1. In the provisionally secured state, the slide member 23, as illustrated in FIG. 4, is positioned in the released state, enabling the second protruding portion 14 to be checked from above. When the slide member 23 that is in this released state is slid in the direction of the arrow Z in FIG. 1, the terminal block 10 that is attached to the controlling device main unit 20 is locked.

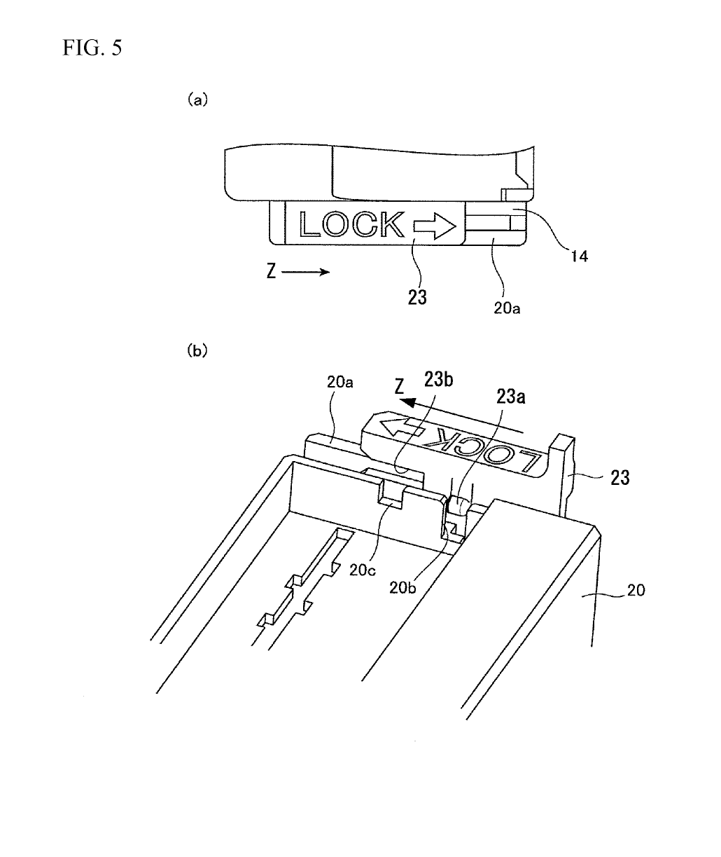

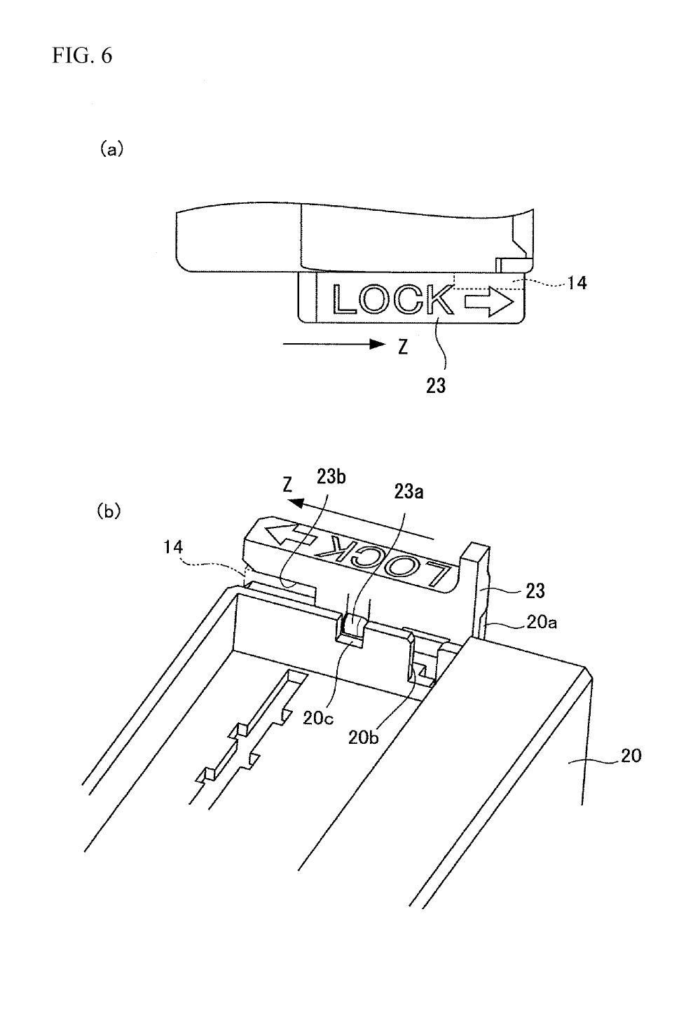

FIG. 5 shows the released state of the slide member 23, and FIG. 6 shows the secured state of the slide member 23. FIG. 5 (a) and FIG. 6 (a) are diagrams showing the slide member 23 from above, and FIG. 5 (b) and FIG. 6 (b) are oblique views showing the securing member 20a, which includes the slide member 23, from the inside of the controlling device main unit 20.

A rectangular fitting groove portion 23b, into which the second protruding portion 14 can fit, is formed on the inside of the slide member 23. Furthermore, a rectangular release position groove 28b and lock position groove 20c, into which the locking portion 23a can fit, are formed in the side face of the controlling device main unit 20 wherein the slide member 23 is provided.

In the released state illustrated in FIG. 5, the locking portion 23a fits in the release position groove 20b, and the second protruding portion 14 is positioned to the outside of the slide member 23. In this released state, when the slide member 23 slides in the Z direction, then, as illustrated in FIG. 6, the second protruding portion 14 of the terminal block 10 and the fitting groove portion 23b of the slide member 23 fit together, and also the locking portion 23a of the slide member 23, which had been fitted in the release position groove 20b, moves in the direction of the Z arrow as it flexes, to fit into the lock position groove 20c, to lock the terminal block 10 that is attached to the controlling device main unit 20.

Writing and Reading Information to/from the IC Chip that Is Embedded in the Terminal Block

In the state wherein the terminal block 10 is attached to the controlling device main unit 20, the IC chip 16 that is embedded in the lower portion of the front face portion of the terminal block 10 is in proximity to the IC chip reader/writer 28 on the printed substrate 26 that is contained within the controlling device main unit 20. The operation for writing/reading information to/from the IC chip 16 by the IC chip reader/writer 28 is controlled by the controlling portion 27 on the printed substrate 25.

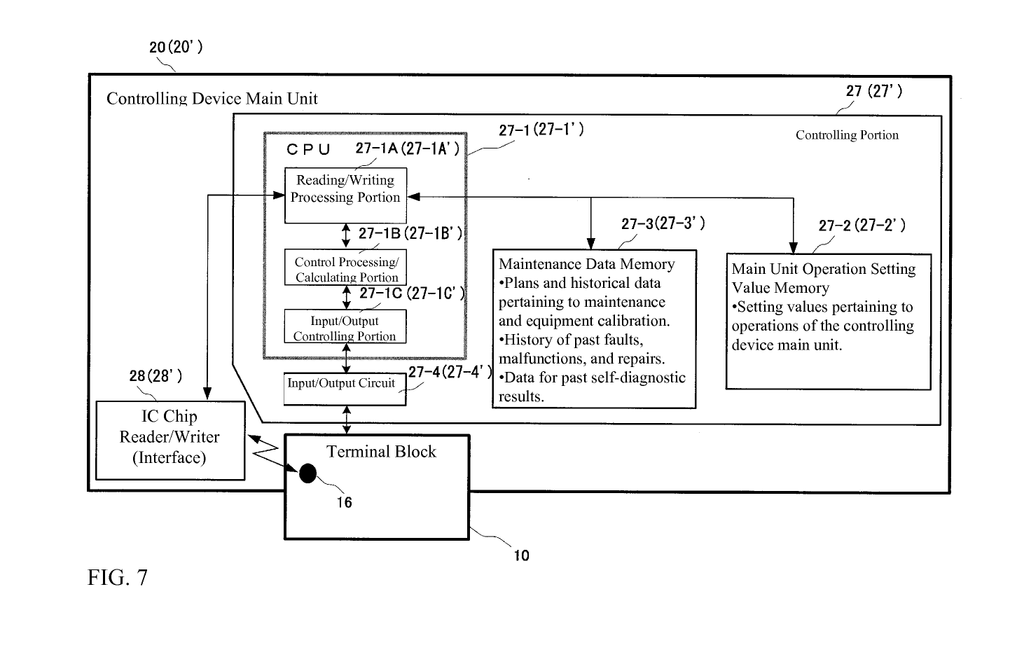

FIG. 7 shows a functional block diagram of the controlling portion 27. The controlling portion 27 is provided with a CPU 27-1, a main unit operation setting value memory 27-2, a maintenance data memory 27-3, and an input/output circuit 27-4. The CPU 27-1 is provided with a reading/writing processing portion 27-1A, a control processing/calculating portion 27-1B, and an input/output controlling portion 27-1C. In the present example, the main unit operation setting value memory 27-2 and maintenance data memory 27-3 are formed from non-volatile memory; however, there is no limitation to being non-volatile memory.

### Normal Operations

At the time of normal operations in a state wherein the terminal block 10 is attached to the controlling device main unit 20, the setting values pertaining to the operation of the controlling device main unit 20 are written to the main unit operation setting value memory 27-2, and information pertaining to maintenance and equipment calibration (schedules and historic data pertaining to maintenance and equipment calibration), information pertaining to faults, malfunctions, and repairs in the past (history of past faults, malfunctions, and repairs), and information such as data for self-diagnostic results from the past are written to the maintenance data memory 27-3.

The information that is written to the main unit operation setting value memory 27-2 and the maintenance data memory 27-3 is sent through the reading/writing processing portion 27-1A in the CPU 27-1 to the IC chip reader/writer 28, and written, as storage data, by the IC chip reader/writer 28 to the IC chip 16, without contact.

When, during the operation of the controlling device main unit 20, there is a change or an update to the information that is written to the main unit operation setting value memory 27-2 or the maintenance data memory 27-3, the control processing/calculating portion 27-1B in the CPU 27-1 updates the storage data of the IC chip 16 as required.

When the Power Supply Is Turned ON during Normal Operations

When the power supply of the controlling device main unit 20 is turned ON, the control processing/calculating portion 27-1B in the CPU 27-1 reads out, through the IC chip reader/writer 28, without contact, the data that is stored in the IC chip 16. The control processing/calculating portion 27-1B compares the data that has been read out to the data that is stored in the main unit operation setting value memory 27-2 and the maintenance data memory 27-3, to identify that setup has been completed. Moreover, the control processing/calculating portion 27-1B verifies the validity of the data that has been read.

If the result of the verification is an evaluation that the terminal block 10 that is attached is valid, then the control processing/calculating portion 27-1B allows the input/output controlling portion 27-1 C to start operations of the input/output circuit 27-4 relative to the terminal block 10, and the operations commence.

### When the Power Supply Is Turned ON When the Controlling Device Main Unit Has Been Swapped Due to a Fault, or the Like

At the time of normal operations, the information in the main unit operation setting value memory 27-2 and the maintenance data memory 27-3 is written as storage data to the IC chip 16.

When the controlling device main unit 20 has been swapped out and the power supply of the controlling device main unit 20′ after swapping is turned ON (where here and below the various portions in the controlling device main unit 20′ after swapping are indicated through the addition of an apostrophe), the control processing/calculating portion 27-1B′ in the CPU 27-1′ of the controlling device main unit 20′ after swapping reads in, through the IC chip reader/writer 28′, the data stored in the IC chip 16, doing so without contact.

The control processing/calculating portion 27-1B′ compares the data that has been read to the data stored in the main unit operation setting value memory 27-2′ and the maintenance data memory 27-3′, and identifies that its own set up has not yet been completed. The control processing/calculating portion 27-1B′ also verifies the validity of the data that has been read.

If the verification result is an evaluation that the terminal block 10 that is attached is valid, the control processing/calculating portion 27-1B′ updates the information in the main unit operation setting value memory 27-2′ with the data that has been read. Moreover, it enables the input/output controlling portion 27-1C′ to start operation of the input/output circuit 27-4′ in relation to the terminal block 10.

As a result, the controlling device main unit 20′, after swapping, is able to start operations immediately by inheriting the setting values based on the information in the updated main unit operation setting value memory 27-2′, that is, based on the setting values pertaining to the operation of the controlling device main unit 20 from prior to the swap.

That is, when the controlling device main unit 20 has been swapped out due to the occurrence of a fault, or the like, the controlling device main unit 20′, after swapping, automatically sets up the setting values pertaining to the operation of the controlling device main unit 20 from prior to the swap, through performing a self-evaluation, thus enabling the operations to restart immediately. Doing so makes it possible to restore operations of the devices or systems controlled by the controlling device 100 rapidly, efficiently, and reliably.

Moreover, the data of the maintenance data memory 27-3 of the controlling device main unit 20 from prior to the swap is stored in the IC chip 16 that is embedded in the terminal block 10, and the controlling device main unit 20′ that is newly installed at the time of the swap operation when the controlling device main unit 20 has failed reads in, from the IC chip 16, the data from the controlling device main unit 20 from prior to the swap, enabling data management to be performed easily and reliably.

### Extended Examples

While the present invention has been explained above in reference to examples, the present invention is not limited to the examples set forth above. The structures and details in the present invention may be varied in a variety of ways, as can be understood by one skilled in the art, within the scope of technology in the present invention.

1. A controlling device comprising:
a controlling device main unit; and
a terminal block attached removably to the controlling device main unit, wherein
the terminal block is provided with an IC chip disposed in a specific position, and
the controlling device main unit is provided with an interface that, in a state wherein the terminal block is attached, is positioned at a position in proximity to the IC chip that is disposed in the terminal block, and reads and writes information from and to the IC chip without contact.

2. The controlling device as set forth in claim 1, wherein
the information written to the IC chip is a setting value pertaining to the operation of the controlling device main unit.

3. The controlling device as set forth in claim 1, wherein
the information written to the IC chip is information pertaining to maintenance or equipment calibration.

4. The controlling device as set forth in claim 1, wherein
the information written to the IC chip is information pertaining to a fault, malfunction, or repair in the past.

5. The controlling device as set forth in claim 1, wherein
the information written to the IC chip is self-diagnostic result data from the past.
